(19) United States
(12) Patent Application Publication
(10) Pub. No.: US 2023/0261798 A1
(43) Pub. Date: Aug. 17, 2023

(54) Complexity Reduction In New Radio Reduced-Capability User Equipment Devices In Mobile Communications

(71) Applicant: MediaTek Singapore Pte. Ltd., Singapore (SG)

(72) Inventors: Jozsef Gabor Nemeth, Cambridge (GB); Mohammed S Aleabe Al-Imari, Cambridge (GB)

(21) Appl. No.: 18/015,950

(22) PCT Filed: Jul. 15, 2021
(86) PCT No.: PCT/CN2021/106564

§ 371 Date: Jan. 12, 2023

Related U.S. Application Data
(60) Provisional application No. 63/051,937, filed on Jul. 15, 2020.
(60) Provisional application No. 63/091,376, filed on Oct. 14, 2020.

(51) Int. Cl. H04L 1/1812; H04L 1/00; H04L 5/14

(52) U.S. Cl. CPC H04L 1/1812; H04L 1/0052; H04L 5/1469

(57) ABSTRACT

Various solutions for complexity reduction in New Radio (NR) reduced-capability user equipment (UE) devices in mobile communications are described. An apparatus, implementable in a UE, applies a configuration that results in reduced complexity in decoding, soft buffering, or both. The apparatus then communicates with a network in a hybrid automatic repeat request (HARQ) procedure with the configuration applied.

### CROSS REFERENCE TO RELATED APPLICATIONS

The present disclosure is part of U.S. National Stage filing of International Patent Application No. PCT/CN2021/06564, filed on 15 Jul. 2021, which is part of a non-provisional application claiming the priority benefit of U.S. Patent Application Nos. 63/051,937 and 63/091,376, filed on 15 Jul. 2020 and 14 Oct. 2020, the contents of which being incorporated by reference in their entirety.

### FIELD OF INVENTION

The present disclosure is generally related to mobile communications and, more particularly, to complexity reduction in New Radio (NR) reduced-capability user equipment (UE) devices in mobile communications.

### BACKGROUND OF THE INVENTION

Unless otherwise indicated herein, approaches described in this section are not prior art to the claims listed below and are not admitted as prior art by inclusion in this section.

In Release 17 (Rel-17) of the 3rd Generation Partnership Project (3GPP) specification(s) for 5th Generation (5G) New Radio (NR) mobile communications, a study item on reduced-capability (Red Cap) device type(s) targets to enable low-end application scenarios by trading off performance for lower UE complexity, power consumption, and form factor. One area for complexity reduction mentioned in the Red Cap Study Item Description (SID) pertains to the memory foot print used by soft buffer for hybrid automatic repeat request (HARQ) processes. Therefore, there is a need for a solution to achieve complexity reduction in NR reduced-capability UE devices.

### SUMMARY OF THE INVENTION

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the issue(s) described herein. More specifically, various schemes proposed in the present disclosure are believed to provide solutions for complexity reduction in NR reduced-capability UE devices in mobile communications.

In one aspect, a method may involve a UE applying a configuration that results in reduced complexity in decoding, soft buffering, or both. The method may also involve the UE communicating with a network in a HARQ procedure with the configuration applied.

In another aspect, an apparatus may include a transceiver and a processor coupled to the transceiver. The transceiver may be configured to communicate wirelessly. The processor may be configured to apply a configuration that results in reduced complexity in decoding, soft buffering, or both. The processor may be also configured to communicate, via the transceiver, with a network in a HARQ procedure with the configuration applied.

It is noteworthy that, although description provided herein may be in the context of certain radio access technologies, networks and network topologies such as 5G/NR mobile communications, the proposed concepts, schemes and any variation(s)/derivative(s) thereof may be implemented in, for and by other types of radio access technologies, networks and network topologies such as, for example and without limitation, Long-Term Evolution (LTE), LTE-Advanced, LTE-Advanced Pro, Internet-of-Things (IoT), Narrow Band Internet of Things (NB-IoT), Industrial Internet of Things (IIoT), vehicle-to-everything (V2X), and non-terrestrial network (NTN) communications. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various proposed schemes in accordance with the present disclosure may be implemented.

FIG. 2 is a block diagram of an example communication apparatus and an example network apparatus in accordance with an implementation of the present disclosure.

FIG. 3 is a flowchart of an example process in accordance with an implementation of the present disclosure.

### DETAILED DESCRIPTION

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to complexity reduction in NR reduced-capability UE devices in mobile communications. According to the present disclosure, a number of possible solutions may be implemented separately or jointly. That is, although these possible solutions may be described below separately, two or more of these possible solutions may be implemented in one combination or another.

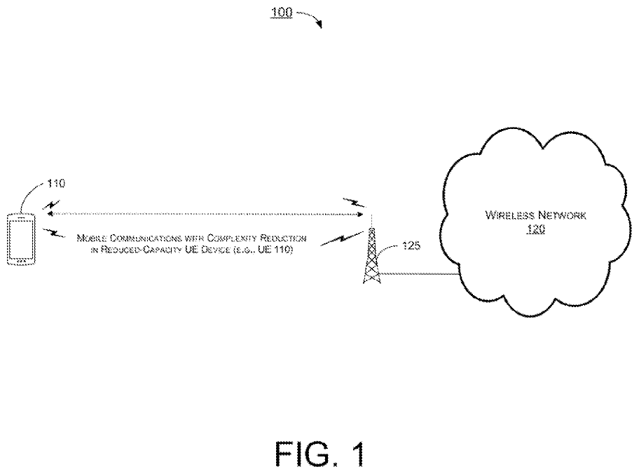

FIG. 1 illustrates an example network environment 100 in which various solutions and schemes in accordance with the present disclosure may be implemented. Referring to FIG. 1, network environment 100 may involve a UE 110 in wireless communication with a wireless network 120 (e.g., a 5G NR mobile network or another type of network such as an NTN). UE 110 may be in wireless communication with wireless network 120 via a base station or network node 125 (e.g., an eNB, gNB or transmit-receive point (TRP)). In network environment 100, UE 110 and wireless network 120 may implement various schemes pertaining to complexity reduction in NR reduced-capability UE devices in mobile communications, as described below.

With respect to soft buffer size for HARQ processes, size reduction requires limiting the number of soft channel bits by each HARQ process and/or the total number of HARQ processes. In Release 15 (Rel-15) and the Release 16 (Rel-16) of the 3GPP specifications for NR, the maximum number of HARQ processes is limited to 16 and must be equal to or greater than the maximum round-trip time (RTT) in slots. In LTE categories soft channel bits are calculated with an RTT=8 transmission time intervals (TTIs), which equals to the number of HARQ processes. At high throughput (e.g., large transport block size (TBS) and/or high coding rate), rate matching is carried out in a transmitter using a limited circular buffer size to allow a reduced soft buffer size on the receiver side. The total number of soft channel bits involved in the receptions over a sliding window of 14 orthogonal frequency-division multiplexing (OFDM) symbols is limited so that it would not surpass the soft channel bits required with limited buffer rate matching (LBRM) at the highest throughput.

LBRM practically truncates the low-density parity-check (LDPC) code, with RLBRM being the resulting LBRM native code rate. LBRM allows reduction in the soft buffer size on the receiver side while reducing the performance benefit from varying redundancy versions (RVs). This is affordable since the block error ratio (BLER) may be very low when maximum throughput is used. Soft channel bits limitation over a consecutive-symbol duration is 1 slot. Section 5.1.3 of the 3GPP Technical Specification (TS) 38.214 V16.0.0, 2019-02 limits the required soft buffering and defines an error case by the following condition:

$${2}^{max ( 0 , μ - {μ}^{′} )} \cdot {\sum }_{i ∈ S} ⌈ \frac{{C}_{i}^{′}}{{L}_{i}} ⌉ {x}_{i} \cdot {F}_{i} > ⌈ \frac{X}{4} ⌉ \cdot \frac{1}{{R}_{LBRM}} \cdot {TBS}_{LBRM}$$

The sum on the left side of the above expression shows the soft channel bits needed by the transmissions that fall within a sliding window of 14 OFDM symbols (with normal cyclic prefix (CP)). In the above expression, S denotes the set of transport blocks (TBs) belonging to physical downlink shared channel(s) (PDSCH(s)) that are contained in the consecutive-symbol duration. Also, X denotes the number of receive chains or branches. Moreover, Lᵢ and xᵢ denote the number of OFDM symbols assigned to the PDSCH and of those contained in the consecutive-symbol duration, respectively. Thus, xᵢ/Lᵢ is proportional to the ratio of PDSCH in the sliding window. Additionally, C′ᵢ denotes the number of scheduled code blocks. Thus, C′ᵢ*Fᵢ is proportional to all soft channel bits related to PDSCH. Also, it is noteworthy that for each PDSCH (or code block group (CBG)), C*F≤C*N_cb≤TBS_{LBRM}/R_{LBRM}. Hence, N_cb denotes the circular buffer size.

When all available resources assigned to the UE are used by a single PDSCH transmission, the condition above is automatically met. The right side of the above expression defines a bound, which roughly scales with the throughput through TBS_{LBRM}, since the other factors are constants in the case of X≤4 layers. Here, R_{LBRM}=⅔ and is a constant.

As alluded above, one simple way to limit the necessary soft buffer size is to limit the number of HARQ processes. The required number of HARQ processes can be determined as the HARQ RTT assumed with the maximum throughput scenario and expressed in the unit of slots, herein referred to as RTT_{Ref} for brevity. Thus, the number of soft channel bits (herein referred to as #Soft_channel_bits) can be expressed as follows:

#Soft_channel_bits=constant*RTT_{Ref}*max_throughput

In the above expression, RTT_{Ref} is in unit of slots while max_throughput is in unit of bits per slot, and constant is a scaling by the native code rate of the forward error coding (FEC) with LBRM.

As can be seen from the above expression, a given soft buffer size can support a lower throughput scenario with relaxed RTT which can be advantageous for multiplexing more acknowledgement (ACK) and negative acknowledgement (NACK) bits into a common codebook so as to render the HARQ transmission more efficient and minimize the On-time of the UE transmitter to reduce dissipated power in the radio frequency (RF) frontend. Therefore, it would be detrimental to UE power consumption and would constrain the scheduling in case soft buffer size were to be limited through the number of maximum HARQ processes. Thus, it would be beneficial to have an explicit bound on the soft buffer size, which a scheduler needs to take into account.

Under a first proposed scheme in accordance with the present disclosure, beyond (or instead) of the quoted bound in Section 5.1.3 of the 3GPP TS 38.214, the total number of soft buffer channel bits may be bounded independently from the number of HARQ processes. Under the proposed scheme, the following condition may be defined:

$${2}^{max ( 0 , μ - {μ}^{′} )} \cdot {\sum }_{i ∈ Z} {C}_{i}^{′} \cdot {F}_{i} > ⌈ \frac{X}{4} ⌉ \cdot \frac{1}{{R}_{LBRM}} \cdot {TBS}_{LBRM} \cdot {RTT}_{Ref}$$

Here, although RTT_{Ref} is expressed in unit of slots, it may take on a non-integer value. In some cases, a UE (e.g., UE 110) may report its soft buffer size to a gNB (e.g., network node 125), yielding RTT_{Ref}. In the above expression, Z denotes the set of TBs belonging to PDSCH(s) that have not been positively acknowledged by UE 110. In case an ACK is missed by network node 125 and is thus retransmitted by UE 110 (e.g., new data indicator (NDI) being non-toggled for the same HARQ process), a respective PDSCH may be included into the set Z as well. For Red Cap NR, the above expression may be simplified due to the reduced capabilities, such as the potential lack of carrier aggregation (CA).

Under the proposed scheme, the 16 HARQ processes mandated for NR may be maintained for relaxed RTT in the case of Red Cap NR. Moreover, the maximum number of soft channel bits for an NR-supporting Red Cap UE device (which is a reduced-capability UE device that supports communications in a NR mobile network based on the 3GPP standard for NR mobile communications) may be limited or otherwise capped separately or independently from the number of HARQ processes (e.g., without reducing the number of HARQ processes) based on the following expression:

Max_soft_channel_bits=Peak_data_rate*RTT_{Ref}/R_{LBRM}

In the above expression, the value of maximum number of soft channel bits (Max_soft_channel_bits) is in unit of bits, the value of peak data rate (Peak_data_rate) is in unit of bits per slot, the value of reference RTT (RTT_{Ref}) is in unit of slots, and R_{LBRM} denotes the LBRM native code rate. The parameter RTT_{Ref} in Frequency Range 1 (FR1) in NR may be based on the time-division dup lexing (TDD) configuration having the longest DL duration.

Under a second proposed scheme in accordance with the present disclosure, LBRM may be optional in downlink (DL) transmissions (as it is in uplink (UL) transmissions), at least for Red Cap UE devices. For instance, a Red Cap UE device may need to recover loss in coverage by, for example, smaller number of reception (Rx) antennae. Under the proposed scheme, a gNB (e.g., network node 125) may configure a UE (e.g., UE 110) with or without LBRM in DL after having detected that the UE is an NR-supporting UE with reduced capability. Moreover, the UE may report its preference to the gNB with respect to LBRM (e.g., for or against LBRM).

Under a third proposed scheme in accordance with the present disclosure, the value of R_{LBRM} may be varied rather than being a constant. For instance, in case of R_{LBRM}>⅔, the required soft buffer size may be further reduced, thereby allowing reduction in UE complexity. On the other hand, in case of R_{LBRM}<⅔, performance may be enhanced, which may be required in wearable devices having a low antenna gain and/or a reduced number of antennae. Under the proposed scheme, a UE (e.g., UE 110) may report its preference for a specific value of R_{LBRM} out of a predefined or configurable set of values. Correspondingly, the gNB (e.g., network node 125) may configure the UE with an R_{LBRM} value after having detected that the UE is an NR-supporting UE with reduced capability.

It is noteworthy that, in Rel-17, in wearable application scenarios the highest peak device data rate considered in the DL is specified as 150 Mbps. This is attainable, for example, with a maximum UE bandwidth of 20 MHz and maximum two spatial transmission layers in DL. Reduction of the number of Rx chains or branches is an essential Red Cap feature in wearable devices for small form factor. Assuming a single component carrier (CC), the number of spatial transmission layers is reduced accordingly. Below 2.5 GHz, current 3GPP standards mandate less antennae for physical reasons such as propagation characteristics and/or antenna size. Similarly, in Red Cap, varying the number of Rx chains/branches and hence varying the maximum number of spatial transmission layers may be determined per carrier frequency range. To target roughly equal peak device data rates at different frequency ranges (with an attempt to keep the complexity for a large part of the baseband constant and tailored to the target scenarios), the variation in the maximum number of transmission layers needs to be compensated for. Accordingly, a solution may involve parameterizing other reduction features to restrict the maximum UE bandwidth, maximum modulation order, maximum modulation coding scheme (MCS), maximum TB size, among other factors. For instance, the complexity of LDPC decoding and soft buffering scales approximately linearly with the peak device data rate. These two functional blocks (namely, LDPC decoding and soft buffering) also account for about ¼ of the baseband complexity. Therefore, the performance of an economic solution may not exceed the targeted peak device data rate.

Under a fourth proposed scheme in accordance with the present disclosure, a Red Cap UE device (e.g., UE 110) may be configured to support different maximum modulation orders (and different MCSs) depending on the maximum number of spatial transmission layers supported at each carrier frequency. In other words, the maximum number of modulation orders supported may depend on the number of spatial transmission layers. Additionally, under the proposed scheme, the Red Cap UE device may be configured to support different maximum modulation orders per layer. For instance, the Red Cap UE device may support either maximum 256-quadrature amplitude modulation (QAM) in DL with one layer or maximum 64-QAM in DL with two layers, depending on the carrier frequency. As another example, for pairs of {X, Y}={256-QAM, 64-QAM} or {64-QAM, 16-QAM}, the Red Cap UE device may support maximum X in a first DL layer and maximum Y in a second DL layer (in case there is the second DL layer).

It is also noteworthy that another possibility is restricting the DL peak device data rate quasi directly (as opposed to indirectly through maximum number of layers and modulation orders, among others) by limiting the number of DL transmission bits from all TBs within a slot or over any sequence of 14 contiguous DL OFCM symbols. Such a restriction can be useful as it does not affect the efficiency of the transmission (as opposed to restrictions on the maximum number of layers and modulation orders, among others) or the co-existence with other NR UEs (as opposed to limiting the maximum UE bandwidth, for example). In other words, such limitation entails limiting the DL TBS_{LBRM} defined in the 3GPP standard. Currently, TBS_{LBRM} is defined in Section 5.4.2.1 of the 3GPP TS 38.212 based largely on the maximum available physical resource available to data transmission at maximum throughput within a slot. On one hand, LBRM uses TBS_{LBRM} in truncating the parity bits written into the circular buffer on the transmitter side. On the other hand, TBS_{LBRM} is also used in expressing the bound for soft buffering requirements and decoding computation complexity on the receiver side. Broadly speaking, the soft buffering necessary to all code blocks received within a sliding window of 14 OFDM symbols is limited by 1.5 times TBS_{LBRM} log-likelihood ratio (LLR) values. The involved code blocks may be from an initial transmission or a retransmission.

Under a fifth proposed scheme in accordance with the present disclosure, a UE (e.g., UE 110) may be configured to support setting an explicit limit on TBS_{LBRM}. For instance, UE 110 may set an explicit limit on TBS_{LBRM} as follows:

TBS_{LBRM}=min(TBSₗᵢₘᵢₜ,TBS_{LBRM_current_standard})

As an example, the common limits as outlined above may be applied when an Frequency Range 2 (FR2) Red Cap device has 50 or 100 MHz maximum bandwidth. As another example, the common limits as outlined above may be applied when an FR1 Red Cap device has 20 or 40 MHz maximum bandwidth. As yet another example, the explicit limit on TBS_{LBRM} may be applicable only for Red Cap UE devices.

Under a sixth proposed scheme in accordance with the present disclosure, a UE (e.g., UE 110) may be configured to support setting separate requirements on the number of DL UE reception layers and the number of UE Rx chains or branches even when the UE supports a single CC. As an example, UE 110 as a Red Cap UE may support two (or one) spatial reception layers only, even when UE 110 has four (or two) Rx chains/branches and supports a single CC. In some cases, the proposed scheme of supporting setting separate requirements on the number of DL UE reception layers and the number of UE Rx chains/branches even when the UE supports a single CC may be applicable only for Red Cap UE devices. For instance, with respect to the maximum number of DL multiple-input-multiple-output (MIMO) layers, one DL MIMO layer may be supported for a Red Cap UE device with one Rx branch, and two DL MIMO layers may be supported for a Red Cap UE device with two Rx branches.

### Illustrative Implementations

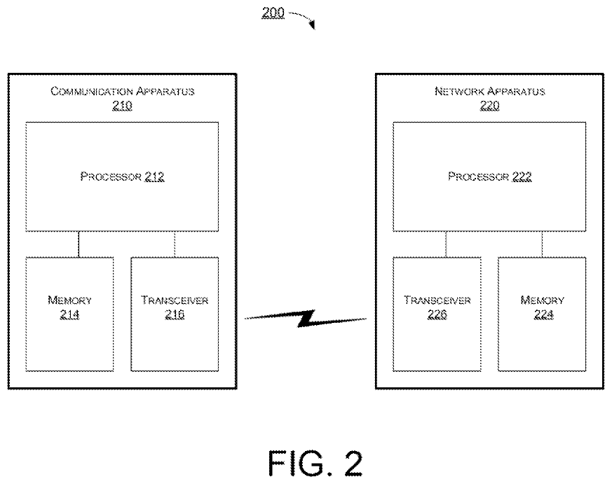

FIG. 2 illustrates an example communication apparatus 210 and an example network apparatus 220 in accordance with an implementation of the present disclosure. Each of communication apparatus 210 and network apparatus 220 may perform various functions to implement schemes, techniques, processes and methods described herein pertaining to complexity reduction in NR reduced-capability UE devices in mobile communications, including scenarios/schemes described above as well as processes 300, 400 and 500 described below.

Communication apparatus 210 may be a part of an electronic apparatus, which may be a UE such as a portable or mobile apparatus, a wearable apparatus, a wireless communication apparatus or a computing apparatus. For instance, communication apparatus 210 may be implemented in a smart phone, a smart watch, a personal digital assistant, a digital camera, or a computing equipment such as a tablet computer, a laptop computer or a notebook computer. Communication apparatus 210 may also be a part of a machine type apparatus, which may be an IoT, NB-IoT, IIoT or NTN apparatus such as an immobile or a stationary apparatus, a home apparatus, a wire communication apparatus or a computing apparatus. For instance, communication apparatus 210 may be implemented in a smart thermostat, a smart fridge, a smart door lock, a wireless speaker or a home control center. Alternatively, communication apparatus 210 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 210 may include at least some of those components shown in FIG. 2 such as a processor 212, for example. Communication apparatus 210 may further include one or more other components not pertinent to the proposed scheme of the present disclosure (e.g., internal power supply, display device and/or user interface device), and, thus, such component(s) of communication apparatus 210 are neither shown in FIG. 2 nor described below in the interest of simplicity and brevity.

Network apparatus 220 may be a part of an electronic apparatus/station, which may be a network node such as a base station, a small cell, a router, a gateway or a satellite. For instance, network apparatus 220 may be implemented in an eNodeB in an LTE, in a gNB in a 5G, NR, IoT, NB-IoT, IIoT, or in a satellite in an NTN network. Alternatively, network apparatus 220 may be implemented in the form of one or more IC chips such as, for example and without limitation, one or more single-core processors, one or more multi-core processors, or one or more RISC or CISC processors. Network apparatus 220 may include at least some of those components shown in FIG. 2 such as a processor 222, for example. Network apparatus 220 may further include one or more other components not pertinent to the proposed scheme of the present disclosure (e.g., internal power supply, display device and/or user interface device), and, thus, such component(s) of network apparatus 220 are neither shown in FIG. 2 nor described below in the interest of simplicity and brevity.

In one aspect, each of processor 212 and processor 222 may be implemented in the form of one or more single-core processors, one or more multi-core processors, or one or more CISC processors. That is, even though a singular term “a processor” is used herein to refer to processor 212 and processor 222, each of processor 212 and processor 222 may include multiple processors in some implementations and a single processor in other implementations in accordance with the present disclosure. In another aspect, each of processor 212 and processor 222 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 212 and processor 222 is a special-purpose machine specifically designed, arranged and configured to perform specific tasks including power consumption reduction in a device (e.g., as represented by communication apparatus 210) and a network (e.g., as represented by network apparatus 220) in accordance with various implementations of the present disclosure.

In some implementations, communication apparatus 210 may also include a transceiver 216 coupled to processor 212 and capable of wirelessly transmitting and receiving data. In some implementations, communication apparatus 210 may further include a memory 214 coupled to processor 212 and capable of being accessed by processor 212 and storing data therein. In some implementations, network apparatus 220 may also include a transceiver 226 coupled to processor 222 and capable of wirelessly transmitting and receiving data. In some implementations, network apparatus 220 may further include a memory 224 coupled to processor 222 and capable of being accessed by processor 222 and storing data therein. Accordingly, communication apparatus 210 and network apparatus 220 may wirelessly communicate with each other via transceiver 216 and transceiver 226, respectively.

Each of communication apparatus 210 and network apparatus 220 may be a communication entity capable of communicating with each other using various proposed schemes in accordance with the present disclosure. To aid better understanding, the following description of the operations, functionalities and capabilities of each of communication apparatus 210 and network apparatus 220 is provided in the context of a mobile communication environment in which communication apparatus 210 is implemented in or as a communication apparatus or a UE (e.g., UE 110) and network apparatus 220 is implemented in or as a network node or base station (e.g., network node 125) of a communication network (e.g., wireless network 120). It is also noteworthy that, although the example implementations described below are provided in the context of mobile communications, the same may be implemented in other types of networks.

Under a proposed scheme pertaining to complexity reduction in NR reduced-capability UE devices in mobile communications in accordance with the present disclosure, with communication apparatus 210 implemented in or as UE 110 and network apparatus 220 implemented in or as network node 125 in network environment 100, processor 212 of communication apparatus 210 may a configuration that results in reduced complexity in decoding, soft buffering, or both. Processor 212 may also communicate, via transceiver 216, with a network (e.g., with network 120 via apparatus 220 as network node 125) in a HARQ procedure with the configuration applied.

In some implementations, in applying the configuration, processor 212 may limit a maximum number of soft channel bits without reducing a number of HARQ processes. In some implementations, the UE may be an NR-supporting UE with reduced capability.

In some implementations, in limiting the maximum number of soft channel bits, processor 212 may set the maximum number of soft channel bits by:

Max_soft_channel_bits=Peak_data_rate*RTT_{Ref}/R_{LBRM},

In the above expression, Max_soft_channel_bits denotes the maximum number of soft channel bits, Peak_data_rate denotes a peak data rate, RTT_{Ref} denotes a HARQ RTT, and R_{LBRM} denotes a limited buffer rate matching (LBRM) native code rate. In some implementations, the RTT_{Ref} may be based on a TDD configuration having a longest DL duration in FR1 in NR mobile communications.

In some implementations, in applying the configuration, processor 212 may limit a maximum number of DL MIMO layers. In some implementations, the UE may be an NR-supporting UE with reduced capability. Moreover, in limiting the maximum number of DL MIMO layers, processor 212 may limit the maximum number of DL MIMO layers to one DL MIMO layer in an event that the UE has one Rx branch. Alternatively, in limiting the maximum number of DL MIMO layers, processor 212 may limit the maximum number of DL MIMO layers to two DL MIMO layers in an event that the UE has two Rx branches.

In some implementations, in applying the configuration, processor 212 may receive, via transceiver 216, the configuration from the network responsive to the network detecting the UE as a reduced-capability UE. In such cases, in communicating with the network, processor 212 may communicate with the network without LBRM in DL transmissions from the network. In some implementations, in receiving the configuration from the network, processor 212 may receive the configuration responsive to reporting to the network a preference for or against the LBRM.

In some implementations, in applying the configuration, processor 212 may perform certain operations. For instance, processor 212 may report to the network a preference for a specific value of a LBRM native code rate. Additionally, processor 212 may receive the configuration from the network responsive to the reporting, with the configuration configuring the UE with the specific value for the LBRM native code rate. In such cases, in communicating with the network, processor 212 may apply the specific value for the LBRM native code rate in the HARQ procedure.

In some implementations, in applying the configuration, processor 212 may support a maximum number of modulation orders based on a number of spatial transmission layers. In some implementations, in supporting the maximum number of modulation orders based on the number of spatial transmission layers, processor 212 may perform certain operations. For instance, processor 212 may perform one of the following: (a) supporting a maximum 256-QAM in DL with one layer; (b) supporting a maximum 64-QAM in DL with two layers; (c) supporting the maximum 256-QAM in a first layer and the maximum 64-QAM in a second layer with the two layers; or (d) supporting the maximum 64-QAM in the first layer and the maximum 256-QAM in the second layer with the two layers. Furthermore, in applying the configuration, processor 212 may support a respective maximum number of modulation orders for each layer of the spatial transmission layers.

In some implementations, in applying the configuration, processor 212 may set a limit on a TBS for LBRM in communicating in the HARQ procedure.

In some implementations, in applying the configuration, processor 212 may set separate requirements on a maximum number of DL reception layers and a number of Rx branches even when the UE supports a single CC. In some implementations, in setting the separate requirements, processor 212 may perform either or both of the following: (a) limiting a number of supported spatial reception layers to half of a maximum number of Rx branches of the UE; and (b) setting of the separate requirements in an event that the UE is a New Radio (NR)-supporting UE with reduced capability.

In some implementations, prior to applying the configuration, processor 212 may perform certain operations. For instance, processor 212 may report, via transceiver 216, a soft buffer size of the UE or a preference related to LBRM to the network. Moreover, processor 212 may receive, via transceiver 216, the configuration from the network responsive to the reporting.

### Illustrative Processes

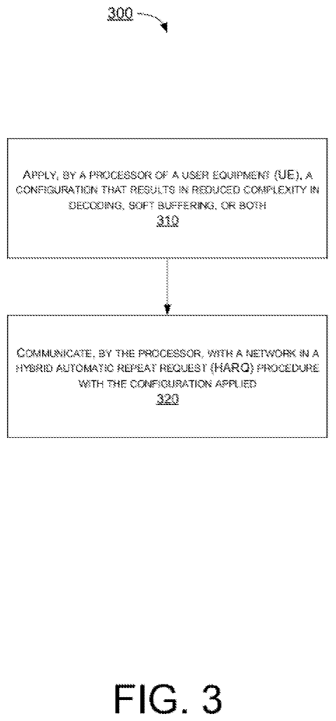

FIG. 3 illustrates an example process 300 in accordance with an implementation of the present disclosure. Process 300 may be an example implementation of schemes described above, whether partially or completely, with respect to complexity reduction in NR reduced-capability UE devices in mobile communications in accordance with the present disclosure. Process 300 may represent an aspect of implementation of features of communication apparatus 210. Process 300 may include one or more operations, actions, or functions as illustrated by one or more of blocks 310 and 320. Although illustrated as discrete blocks, various blocks of process 300 may be divided into additional blocks, combined into fewer blocks, or eliminated, depending on the desired implementation. Moreover, the blocks of process 300 may executed in the order shown in FIG. 3 or, alternatively, in a different order. Process 300 may be implemented by communication apparatus 210 or any suitable UE or machine type devices. Solely for illustrative purposes and without limitation, process 300 is described below in the context of communication apparatus 210 and network apparatus 220. Process 300 may begin at block 310.

At 310, process 300 may involve processor 212 of communication apparatus 210 applying a configuration that results in reduced complexity in decoding, soft buffering, or both. Process 300 may proceed from 310 to 320.

At 320, process 300 may involve processor 212 communicating, via transceiver 216, with a network (e.g., network 120 via apparatus 220 as network node 125) in a HARQ procedure with the configuration applied.

In some implementations, in applying the configuration, process 300 may involve processor 212 limiting a maximum number of soft channel bits without reducing a number of HARQ processes. In some implementations, the UE may be an NR-supporting UE with reduced capability.

In some implementations, in limiting the maximum number of soft channel bits, process 300 may involve processor 212 setting the maximum number of soft channel bits by:

Max_soft_channel_bits=Peak_data_rate*RTT_{Ref}/R_{LBRM},

In the above expression, Max_soft_channel_bits denotes the maximum number of soft channel bits, Peak_data_rate denotes a peak data rate, RTT_{Ref} denotes a HARQ RTT, and R_{LBRM} denotes a limited buffer rate matching (LBRM) native code rate. In some implementations, the RTT_{Ref} may be based on a TDD configuration having a longest DL duration in FR1 in NR mobile communications.

In some implementations, in applying the configuration, process 300 may involve processor 212 limiting a maximum number of DL MIMO layers. In some implementations, the UE may be an NR-supporting UE with reduced capability. Moreover, in limiting the maximum number of DL MIMO layers, process 300 may involve processor 212 limiting the maximum number of DL MIMO layers to one DL MIMO layer in an event that the UE has one Rx branch. Alternatively, in limiting the maximum number of DL MIMO layers, process 300 may involve processor 212 limiting the maximum number of DL MIMO layers to two DL MIMO layers in an event that the UE has two Rx branches.

In some implementations, in applying the configuration, process 300 may involve processor 212 receiving the configuration from the network responsive to the network detecting the UE as a reduced-capability UE. In such cases, in communicating with the network, process 300 may involve processor 212 communicating with the network without LBRM in DL transmissions from the network. In some implementations, in receiving the configuration from the network, process 300 may involve processor 212 receiving the configuration responsive to reporting to the network a preference for or against the LBRM.

In some implementations, in applying the configuration, process 300 may involve processor 212 performing certain operations. For instance, process 300 may involve processor 212 reporting to the network a preference for a specific value of a LBRM native code rate. Additionally, process 300 may involve processor 212 receiving the configuration from the network responsive to the reporting, with the configuration configuring the UE with the specific value for the LBRM native code rate. In such cases, in communicating with the network, process 300 may involve processor 212 applying the specific value for the LBRM native code rate in the HARQ procedure.

In some implementations, in applying the configuration, process 300 may involve processor 212 supporting a maximum number of modulation orders based on a number of spatial transmission layers. In some implementations, in supporting the maximum number of modulation orders based on the number of spatial transmission layers, process 300 may involve processor 212 performing certain operations. For instance, process 300 may involve processor 212 performing one of the following: (a) supporting a maximum 256-QAM in DL with one layer; (b) supporting a maximum 64-QAM in DL with two layers; (c) supporting the maximum 256-QAM in a first layer and the maximum 64-QAM in a second layer with the two layers; or (d) supporting the maximum 64-QAM in the first layer and the maximum 256-QAM in the second layer with the two layers. Furthermore, in applying the configuration, process 300 may involve processor 212 supporting a respective maximum number of modulation orders for each layer of the spatial transmission layers.

In some implementations, in applying the configuration, process 300 may involve processor 212 setting a limit on a TBS for LBRM in communicating in the HARQ procedure.

In some implementations, in applying the configuration, process 300 may involve processor 212 setting separate requirements on a maximum number of DL reception layers and a number of Rx branches even when the UE supports a single CC. In some implementations, in setting the separate requirements, process 300 may involve processor 212 performing either or both of the following: (a) limiting a number of supported spatial reception layers to half of a maximum number of Rx branches of the UE; and (b) setting of the separate requirements in an event that the UE is a New Radio (NR)-supporting UE with reduced capability.

In some implementations, prior to applying the configuration, process 300 may involve processor 212 performing certain operations. For instance, process 300 may involve processor 212 reporting, via transceiver 216, a soft buffer size of the UE or a preference related to LBRM to the network. Moreover, process 300 may involve processor 212 receiving, via transceiver 216, the configuration from the network responsive to the reporting.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

1. A method, comprising:
applying, by a processor of a user equipment (UE), a configuration that results in reduced complexity in decoding, soft buffering, or both; and
communicating, by the processor, with a network in a hybrid automatic repeat request (HARQ) procedure with the configuration applied.

2. The method of claim 1, wherein the applying of the configuration comprises limiting a maximum number of soft channel bits without reducing a number of HARQ processes.

3. The method of claim 2, wherein the limiting of the maximum number of soft channel bits comprises setting the maximum number of soft channel bits by:
Max_soft_channel_bits=Peak_data_rate*RTT_{Ref}/R_{LBRM},
wherein:
Max_soft_channel_bits denotes the maximum number of soft channel bits,
Peak_data_rate denotes a peak data rate,
RTT_{Ref} denotes a HARQ round-trip time (RTT), and
R_{LBRM} denotes a limited buffer rate matching (LBRM) native code rate.

4. The method of claim 3, wherein the RTT_{Ref} is based on a time-division duplexing (TDD) configuration having a longest downlink (DL) duration in Frequency Range 1 (FR1) in New Radio (NR) mobile communications.

5. The method of claim 2, wherein the UE comprises a New Radio (NR)-supporting UE with reduced capability.

6. The method of claim 1, wherein the applying of the configuration comprises limiting a maximum number of downlink (DL) multiple-input-multiple-output (MIMO) layers.

7. The method of claim 6, wherein the UE comprises a New Radio (NR)-supporting UE with reduced capability, and wherein the limiting of the maximum number of DL MIMO layers comprises:
limiting the maximum number of DL MIMO layers to one DL MIMO layer in an event that the UE has one receive (Rx) branch; or
limiting the maximum number of DL MIMO layers to two DL MIMO layers in an event that the UE has two Rx branches.

8. The method of claim 1, wherein the applying of the configuration comprises receiving the configuration from the network responsive to the network detecting the UE as a reduced-capability UE, and wherein the communicating with the network comprises communicating with the network without limited buffer rate matching (LBRM) in downlink (DL) transmissions from the network.

9. The method of claim 8, wherein the receiving of the configuration from the network comprises receiving the configuration responsive to reporting to the network a preference for or against the LBRM.

10. The method of claim 1, wherein the applying of the configuration comprises:
reporting to the network a preference for a specific value of a limited buffer rate matching (LBRM) native code rate;
receiving the configuration from the network responsive to the reporting, with the configuration configuring the UE with the specific value for the LBRM native code rate,
wherein the communicating with the network comprises applying the specific value for the LBRM native code rate in the HARQ procedure.

11. The method of claim 1, wherein the applying of the configuration comprises supporting a maximum number of modulation orders based on a number of spatial transmission layers.

12. The method of claim 11, wherein the supporting of the maximum number of modulation orders based on the number of spatial transmission layers comprises:
supporting a maximum 256-quadrature amplitude modulation (QAM) in downlink (DL) with one layer;
supporting a maximum 64-QAM in DL with two layers;
supporting the maximum 256-QAM in a first layer and the maximum 64-QAM in a second layer with the two layers; or
supporting the maximum 64-QAM in the first layer and the maximum 256-QAM in the second layer with the two layers.

13. The method of claim 11, wherein the applying of the configuration further comprises supporting a respective maximum number of modulation orders for each layer of the spatial transmission layers.

14. The method of claim 1, wherein the applying of the configuration comprises setting a limit on a transport block size (TBS) for limited buffer rate matching (LBRM) in communicating in the HARQ procedure.

15. The method of claim 1, wherein the applying of the configuration comprises setting separate requirements on a maximum number of downlink (DL) reception layers and a number of receive (Rx) branches even when the UE supports a single component carrier (CC).

16. The method of claim 15, wherein the setting of the separate requirements comprises either or both of:
limiting a number of supported spatial reception layers to half of a maximum number of Rx branches of the UE; and
setting of the separate requirements in an event that the UE is a New Radio (NR)-supporting UE with reduced capability.

17. The method of claim 1, further comprising, prior to applying the configuration:
reporting, by the processor, a soft buffer size of the UE or a preference related to limited buffer rate matching (LBRM) to the network; and
receiving, by the processor, the configuration from the network responsive to the reporting.

18. An apparatus implementable in a user equipment (UE), comprising:
a transceiver configured to communicate wirelessly; and
a processor coupled to the transceiver and configured to perform operations comprising:
applying a configuration that results in reduced complexity in decoding, soft buffering, or both; and
communicating, via the transceiver, with a network in a hybrid automatic repeat request (HARQ) procedure with the configuration applied.

19. The apparatus of claim 18, wherein, in applying the configuration, the processor is configured to limit a maximum number of soft channel bits without reducing a number of HARQ processes by setting the maximum number of soft channel bits by:
Max_soft_channel_bits=Peak_data_rate*RTT_{Ref}/R_{LBRM},
wherein:
Max_soft_channel_bits denotes the maximum number of soft channel bits,
Peak_data_rate denotes a peak data rate,
RTT_{Ref} denotes a HARQ round-trip time (RTT), and
R_{LBRM} denotes a limited buffer rate matching (LBRM) native code rate.

20. The apparatus of claim 18, wherein, in applying the configuration, the processor is configured to limit a maximum number of downlink (DL) multiple-input-multiple-output (MIMO) layers by:
limiting the maximum number of DL MIMO layers to one DL MIMO layer in an event that the UE has one receive (Rx) branch; or
limiting the maximum number of DL MIMO layers to two DL MIMO layers in an event that the UE has two Rx branches.
